(19) United States
(12) Patent Application Publication
(10) Pub. No.: US 2025/0303401 A1
(43) Pub. Date: Oct. 2, 2025

(54) SUPPORT-ENABLED ALKANES DEHYDROGENATION BY ORGANOMETALLIC ON METAL NITRIDES

(71) Applicant: UChicago Argonne, LLC, Chicago, IL (US)

(72) Inventors: David Kaphan, Oak Park, IL (US); Massimiliano Delferro, Chicago, IL (US); Joshua DeMuth, Naperville, IL (US)

(73) Assignee: UChicago Argonne, LLC, Chicago, IL (US)

(21) Appl. No.: 18/617,601

(22) Filed: Mar. 26, 2024

(51) Int. Cl. B01J 31/16; B01J 27/24

(52) U.S. Cl. CPC B01J 31/1616; B01J 27/24; B01J 2231/76; B01J 2531/48

(57) ABSTRACT

A catalytic composition and process for forming and utilizing same in alkane dehydrogenation. An organometallic active material is deposited onto a silicon derived support such as a silicon imidonitride or silicon oxynitride. The active material facilitates the heterolytic C—H bond cleavage across a metal oxide bond.

### STATEMENT OF GOVERNMENT INTEREST

This invention was made with government support under Contract No. DE-AC02-06CH11357 awarded by the United States Department of Energy to UChicago Argonne, LLC, operator of Argonne National Laboratory. The government has certain rights in the invention.

### TECHNICAL FIELD

The present disclosure relates generally to support-enabled alkane dehydrogenation for organometal on silicon.

### BACKGROUND

A number of viable approaches to catalyst synthesis are known. One approach is surface organometallic chemistry (“SOMC”). SOMC provides a strategy for the generation of well-defined supported precatalyst structures, both as model complexes to gain insights into industrially relevant processes. In addition, SOMC can provide for the generation of highly active and selective catalysts in their own right. SOMC provides a number of advantages for catalyst products, including the ability to perform the rational design of surface species through structure-activity studies, generation of highly reactive and often undercoordinated or distorted surface species that are inaccessible with traditional molecular synthesis techniques, and site isolation preventing multi-nuclear deactivation or passivation. Traditionally, SOMC catalysts have employed predominantly metal oxide surfaces (e.g., SiO₂, TiO₂, Al₂O₃, MgO, etc.), which each promote differing chemistries based on differences in the relative abundance and strength of Lewis and Bronsted acid and base sites. This approach has a drawback, as there is a limited breadth of accessible chemical space within the oxides.

The study of SOMC catalysts as model systems has provided valuable insights into the mechanism and catalyst design principles of many industrial processes including dehydrogenation, polymerization, and olefin metathesis. Alkane dehydrogenation processes are important to producing industrial and commercial products, for example conversion of ethane to ethylene, propane to propylene, butane to butanes and butadienes, polyethylene to dehydrogenated polyethylene. Propane dehydrogenation, in large part due to the industrial demand, has been a significant area of focus, leading to several well-defined active sites for dehydrogenation as well as resulting in significant mechanistic insights in this particular space.

### SUMMARY

Expanding the field of SOMC catalysis beyond traditional oxides has the potential to provide powerful tools for modulation of catalyst behavior and expand the accessible repertoire of reaction mechanism and reaction conditions.

One embodiment relates to a catalyst composition comprising a support material comprising Si(_{3-(x/4})) (NH)ₓ N(₄₋ₓ), where X is 0-4 or SiₐOₓN_{y}; and an active material comprising a metal-ligand complex wherein a metal is selected from the group consisting of Cr, Ga, V, Fe, Co, and Zr.

A further embodiment relates to a method of preparing a propane dehydrogenation catalyst comprising forming a catalytic support comprising Si(_{3-(x/4)}) (NH)ₓ N(₄₋ₓ), where X is 0-4 or SiₐOₓN_{y} and grafting a metal-ligand complex onto the catalytic support.

This summary is illustrative only and is not intended to be in any way limiting. Other aspects, inventive features, and advantages of the devices or processes described herein will become apparent in the detailed description set forth herein, taken in conjunction with the accompanying figures, wherein like reference numerals refer to like elements.

### BRIEF DESCRIPTION OF DRAWINGS

The foregoing and other features of the present disclosure will become more fully apparent from the following description and appended claims, taken in conjunction with the accompanying drawings. Understanding that these drawings depict only several implementations in accordance with the disclosure and are, therefore, not to be considered limiting of its scope, the disclosure will be described with additional specificity and detail through use of the accompanying drawings.

FIG. 1 shows previous non-oxidative propane dehydrogenation (“PDH”)catalysts prepared by a SOMC approach and the catalyst employed in this work for PDH.

FIG. 2A shows grafting of ZrBn₄ on Si₃N₄. FIG. 2B shows diffuse reflectance infrared Fourier transform spectroscopy (“DRIFTS”) spectra of Si₃N₄ and Zr/Si₃N₄. Difference spectrum shown in inset. FIG. 2C shows extended X-ray absorption fine structure (“EXAFS”) spectra (k²-weighted, k=3-11 Å⁻¹) Zr/Si₃N₄, Zr/SiO₂, and ZrBn₄ with tabulated Zr-ligand coordination number (N) and bond distance (R). FIG. 2D shows dynamic nuclear polarization (“DNP”)-enhanced ¹⁵N cross-polarization magic angle spinning (“CPMAS”) nuclear magnetic resonance (“NMR”) spectrum of Si₃N₄ and Zr/Si₃N₄. FIG. 2E shows DNP-enhanced CPMAS ²⁹Si NMR spectra of Si₃N₄ and Zr/Si₃N₄. FIG. 2F shows DNP-enhanced ¹³C{¹H}heteronuclear correlation (“HETCOR”) spectrum of Zr/Si₃N₄. * corresponds to residual pentane trapped in micropores (see FIG. 23).

FIG. 3A shows PDH conversion catalyzed by Zr/Si₃N₄ and Zr/SiO₂, and propene selectivity for Zr/Si₃N₄. FIG. 3B shows proposed C—H activation barriers and reaction energies for Zr/Si₃N₄ and Zr/SiO₂ catalyzed C—H activation of propane.

FIGS. 4A-4B show preparation of silicon nitride (Si₃N₄). A silicon diimide intermediate is prepared via dehalogenation of silicon tetrachloride with anhydrous ammonia gas. Ammonium chloride is generated as a byproduct of the dehalogenation. (FIG. 4A) Heating to 1000° C. sublimes of the byproduct and converts the silicon diimide into silicon nitride. Subsequent vacuum treatment at 200° C. is performed to drive off physiosorbed ammonia and control surface acid site density. (FIG. 4B).

FIG. 5 shows 77° K nitrogen isotherm adsorption and desorption plot for Si₃N₄.

FIGS. 6A-6B show Brunauer-Emmett-Teller (“BET”) surface area plot (FIG. 6A) and Rouquerol BET plot (FIG. 6B) showing selected points for BET surface area analysis. BET surface area: 485.7335±1.1724 m²/g, Slope: 0.008826±0.000021 g/cm³ STP, Y-intercept: 0.000135±0.000004 g/cm³ STP, C: 66.589335, Qm: 111.5967 cm³/g STP, Correlation coefficient: 0.9999190, Molecular cross-sectional area: 0.1620 nm².

FIG. 7 shows a plot of pore size distribution for Si₃N₄ calculated from nitrogen isotherm data. The distribution is bimodal with mesoporous range centered about 9 nm and microporous range centered about 1.6 nm.

FIG. 8 shows ¹H NMR analysis following addition of a solution of Bn₂Mg(THF)₂ (titrant), 1,3,5-tritertbutylbenzene (internal standard), in C₆D₆ to a slurry of Si₃N₄ in C₆D₆ in a J. Young NMR tube.

FIGS. 9A-9C show surface Bronsted acid site titration of Si₃N₄ using Bn₂Mg(THF)₂ as the titrant. Plot of mmol Bn₂Mg(THF)₂ remaining in solution (ungrafted), mmol Bn₂Mg(THF)₂ grafted, and mmol toluene formed throughout the course of the titration (FIG. 9A). Plot of acid sites titrated per square nanometer throughout the course of the titration (FIG. 9B). Plot of toluene formed per Bn₂Mg(THF)₂ grafted (mmol/mmol) throughout the course of the titration (FIG. 9C).

FIG. 10 shows DNP-enhanced ¹⁵N CPMAS NMR spectra acquired with short and long contact times (top) and ¹⁵N{¹H}HETCOR spectrum (bottom) acquired in the Si₃N₄ sample.

FIG. 11 shows ¹H NMR analysis of ZrBn₄ grafting on Si₃N₄. The spectrum shows the consumption of ZrBn₄ and concomitant generation of toluene from protonolysis of the Zr—C bonds from surface acid sites on the silicon nitride.

FIGS. 12A-12C show Results from ¹H NMR analysis of the supernatant following addition of a solution of ZrBn₄ in C₆D₆ to Si₃N₄ pre-soaked in C₆D₆ in a J. Young NMR tube. FIG. 12A is a plot showing the amount (mmol) of ZrBn₄ remaining ungrafted, ZrBn₄ consumed by grafting, and toluene over the course of 72 h. FIG. 12B is a plot showing grafted Zr per nm² (based on BET surface area 485 m2/g) over the course of 72 h. FIG. 12C is a plot showing toluene produced per ZrBn₄ grafted over the course of 72 h.

FIG. 13 shows DRIFTS spectrum of ZrBn₄.

FIG. 14 shows difference spectra in N—H and C—H stretching region from DRIFTS analysis of Si₃N₄ and Zr/Si₃N₄ using multiple scaling factors.

FIG. 15 is a line fitting plot of DRIFTS spectrum of Si₃N₄. Signals were fit to bands at νₛ(NH₂)=3490 cm−1, νₐₛ(NH₂)=3404 cm⁻¹, ν(NH)=3357 cm⁻¹, and an additional νs(NH)=3289 cm⁻¹ to account for a range of local environments on this NH band. The calculated NH₂:NH peak area ratio was 0.18:1.

FIG. 16 shows difference spectra in NH₂ bending and C—C stretching region from DRIFTS analysis of Si₃N₄ and Zr/Si₃N₄ using multiple scaling factors.

FIG. 17 is a line fitting plot of DRIFTS spectrum of Zr/Si₃N₄. Signals were fit to bands at νₛ(NH₂)=3479 cm⁻¹, νₐₛ(NH₂)=3392 cm⁻¹, ν(NH)=3352 cm¹, and an additional νₛ(NH)=3319 cm⁻¹ to account for a range of local environments on this NH band. The calculated NH₂:NH peak area ratio was 0.11:1. The decrease in this ratio in comparison to Si₃N₄(FIG. 15) may suggest a preference for Zr grafting to NH₂ over NH.

FIG. 18 shows Zr K-edge EXAFS of Zr/Si₃N₄ using an R_{bkg} parameter of 1.1 versus 0.7. * corresponds to the feature associated with the atomic background (k³-weighted spectra, k=3-11 Å⁻¹).

FIG. 19 shows Zr K-edge x-ray absorption near edge structure (“XANES”) of Zr/Si₃N₄, Zr/SiO₂, ZrBn₄, and tetragonal ZrO₂.

FIG. 20 shows offset Zr K-edge k³ x(k) spectra of (i) Zr/SiO₂, (ii) Zr/Si₃N₄, and ZrBn₄.

FIG. 21 shows Zr K-edge EXAFS of Zr/Si₃N₄, Zr/SiO₂, and ZrBn₄ (k³-weighted, k=3-11 Å⁻¹).

FIGS. 22A-22B show Zr K-edge EXAFS fitting results for Zr/Si₃N₄(FIG. 22A) and Zr/SiO₂ (FIG. 22B) (k³-weighted, k=3-11 Å⁻¹).

FIG. 23 shows DRIFTS spectra of pentane washed Si₃N₄, as prepared Si₃N₄, and Zr/Si₃N₄. C—H stretching feature (2800-3100 cm⁻¹) present in the washed Si₃N₄ DRIFTS spectrum is consistent with residual pentane on the surface likely trapped in the micropores. Attempts were made to remove this pentane on Zr/Si₃N₄ by longer drying time under vacuum and heating under vacuum, which resulted in the loss of color suggesting decomposition of the catalyst.

FIG. 24 shows conversion of propane from Zr/Si₃N₄ catalyzed propane dehydrogenation at 450° C. with 2% propane (balance argon) flowing at 5 mL/min. Conversion is based on product gases only and total conversion based on propane concentration out versus propane concentration in.

FIG. 25 is a plot showing conversion and selectivity of propane from Zr/Si₃N₄ catalyzed propane dehydrogenation at 450° C. with 2% propane (balance argon) flowing at 5 mL/min. Conversion is based on product gases only.

FIG. 26 is a plot of mol % of hydrogen gas and propene formed during Zr/Si₃N₄ catalyzed PDH at 450° C. with 2% propane (argon balance) flowing at 5 mL/min.

FIG. 27 shows Zr/Si₃N₄ catalyzed PDH at 550° C. with 2% propane (balance argon) flowing at 5 mL/min. Plot shows conversion of propane and selectivity for propylene formation. Values are based on product gas concentrations versus initial propane gas concentration.

FIG. 28 shows Zr/Si₃N₄ catalyzed PDH at 550° C. with 2% propane (balance argon) flowing at 20 mL/min. Plot shows conversion of propane and selectivity for propylene formation. Values are based on product gas concentrations versus initial propane gas concentration.

FIG. 29 shows Si₃N₄ catalyzed PDH at 550° C. with 2% propane (balance argon) flowing at 5 mL/min. Plot shows conversion of propane and selectivity for propylene formation. Values are based on product gas concentrations versus initial propane gas concentration.

FIG. 30 shows Zr/SiO₂ catalyzed PDH at 550° C. with 2% propane (balance argon) flowing at 20 mL/min. Plot shows conversion of propane and selectivity for propylene formation. Values are based on product gas concentrations versus initial propane gas concentration.

FIGS. 31A-31D show DFT-optimized geometries of cluster models for the C—H activation in PDH Zr/SiO₂ (FIG. 31A), Zr/Si₃N₄ with the Zr—N amido groups (FIG. 31B), Zr/Si₃N₄ with the Zr—N amido groups in a different site (FIG. 31C), and Zr/Si₃N₄ with the Zr═N imido group (FIG. 31D). Blue: N, Beige: Si, White: H, Sky blue: Zr, Grey: C, Red: O.

FIG. 32 shows energy profile in kcal/mol for the C—H activation in PDH for the four cluster models (see FIGS. 31A-31D). Zr/Si₃N₄-1 includes the Zr—N amido groups, Zr/Si₃N₄-2 is a different active site from Zr/Si₃N₄-1 with the Zr—N amido groups, and Zr/Si₃N₄-3 is the active site with the Zr═N imido group.

FIG. 33 illustrates a process for forming grafted (FeMes₂)₂ (where Mes is deprotonated mesitylene) on a silicon nitride substrate, specifically for NMR analysis.

FIG. 34 is the results from ¹H NMR analysis of the supernatant following addition of a solution of (FeMes₂)₂ in C₆D₆ to Si₃N₄ pre-soaked in C₆D₆ in a J. Young NMR tube. Plot showing the amount (mmol) of (FeMes₂)₂ remaining ungrafted, (FeMes₂)₂ consumed by grafting, and mesitylene over the course of 150 h.

FIG. 35 is a graph of the ratio of MesH to Fe (grafted) over time.

FIG. 36A is graph of x-ray absorption spectroscopy data XANES showing normalized absorption versus energy for various materials including iron on silica, iron on silicon nitride, (FeMes₂)₂, FeO and iron. FIG. 36B is EXAFS data indicating the radial distance of the iron on silica, iron on silicon nitride, and (FeMes₂)₂. FIG. 36C provides a further characterization of the grafted and ungrafted silicon nitride by DRIFTS over a 3650 to 650 wavelength span indicating a large peak below 1250 and peaks associated with NH₂, NH, and OH presence. FIG. 36D provides a further characterization of the grafted and ungrafted silicon nitride by DRIFTS, focused at the wavelengths above the peak seen in FIG. 36C, showing the peaks associated with NH₂, NH, and OH presence.

FIG. 37A illustrates the propane dehydrogenation process for Fe/Si₃N₄ utilized for the results data shown in FIG. 37B. FIG. 37B shows the results, in both percent conversion and percent selectivity, over time for experiments for propane dehydrogenation of FIG. 37A at both 450° C. and 550° C.

FIG. 38A is graph of XANES data showing normalized absorption versus energy for various materials including Cr on silica, Cr on silicon nitride, CrLiₓSi₃N₄, and CrLiₓSiO₂. FIG. 38B is graph of XANES data showing normalized absorption versus energy for various materials including V on silica, V on silicon nitride, V on silica, and V(III) Mesₓ.

FIG. 39A shows the results, in both percent conversion and percent selectivity, over time for experiments for propane dehydrogenation at both 450° C. FIG. 39B shows the results, in both percent conversion and percent selectivity, over time for experiments for propane dehydrogenation of FIG. 37A at 550° C.

FIG. 40 illustrates the polyethelyene dehydrogenation process for Cr/Si₃N₄ as well as the resultant comparison of the dehydrogenation for the silicon nitride and silica substrates with the Cr grafted on.

Reference is made to the accompanying drawings throughout the following detailed description. In the drawings, similar symbols typically identify similar components, unless context dictates otherwise. The illustrative implementations described in the detailed description, drawings, and claims are not meant to be limiting. Other implementations may be utilized, and other changes may be made, without departing from the spirit or scope of the subject matter presented here. It will be readily understood that the aspects of the present disclosure, as generally described herein, and illustrated in the figures, can be arranged, substituted, combined, and designed in a wide variety of different configurations, all of which are explicitly contemplated and made part of this disclosure.

### DETAILED DESCRIPTION OF VARIOUS EMBODIMENTS

It should be understood that the present disclosure is not limited to the details of methodology set forth in the description or illustrated in the figures. It should also be understood that the terminology used herein is for the purpose of description only and should not be regarded as limiting.

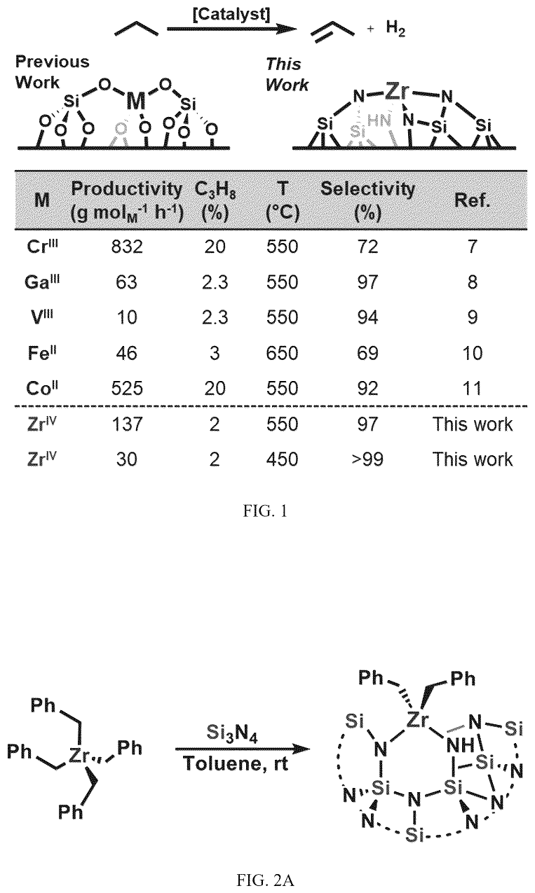

Traditionally, propene has been produced as a byproduct in oil refining and ethylene production. However, the growing demand for polypropylene has created a gap in propene production from these sources. The current solution to address this gap has been the development of catalytic methods to convert propane from abundant US shale gas into propene via both oxidative (“OPDH”) and non-oxidative propane dehydrogenation (“PDH”). Although propane dehydrogenation is primarily used in the examples included herein, it should be appreciated that the methods, systems, and materials may further be selected for and applicable to other alkane dehydrogenation. While several processes have been identified, the primary processes used for industrial PDH are the Catofin and the Oleflex processes, which rely on heterogeneous catalysts derived from chromium oxide supported on alumina and Sn-doped Pt supported on alumina, respectively. The SOMC approach has been used to develop some non-oxidative PDH systems, including those using metal ions (e.g., Cr, Ga, V, Fe, Co) grafted on metal oxide surfaces (FIG. 1). These SOMC systems have been further investigated to identify the underlying mechanistic pathways associated with the catalytic method. These mechanistic studies have shown that the dominant pathway the non-oxidative PDH systems involves heterolytic C—H bond cleavage across the metal oxide bond as the rate limiting-step.

One embodiment herein relates to catalyst materials having a metal-nitride supported active site rather than the well-understood metal-oxide. It is hypothesized that use of nitrogen-based supports for this catalytic process provides improved results due to the increased basicity of the nitrogen ligand that will lower the barrier to heterolytic C—H activation. Further, the metal nitride-supported active site environment may also stabilize the isolated sites with increased covalency and orbital overlap, increase active site electron density, and enable the possibility of alternative bond activation mechanisms involving heterolytic cleavage at a M=N transition metal imido group.

While nitrogen's impact on SOMC supports has been considered by Bassett and coworkers, their approach focused on utilizing the existing silicon oxide structure modified by nitrogen. Specifically, prior work focused on treating a silicon oxide support with ammonia, establishing a bulk oxide support with an aminated surface. When this aminated surface was metalated with an organozirconium complex, a significant enhancement in C—H and C—C bond activation for alkane hydrogenolysis via a σ-bond metathesis mechanism with a persistent zirconium hydride was observed. However, such work was tied to the use of the silicon oxide as the underlying support structure, thus resulting in only a metastable nitrogen coordination sphere, with ligand transfer to the surface generating new oxygen donors. While silicon oxide is a heavily favored support, it has been discovered that its use in this situation results in a catalyst that is not viable for certain catalytic processes at elevated temperatures or under relatively harsh conditions due to the reliance on the metastable structure.

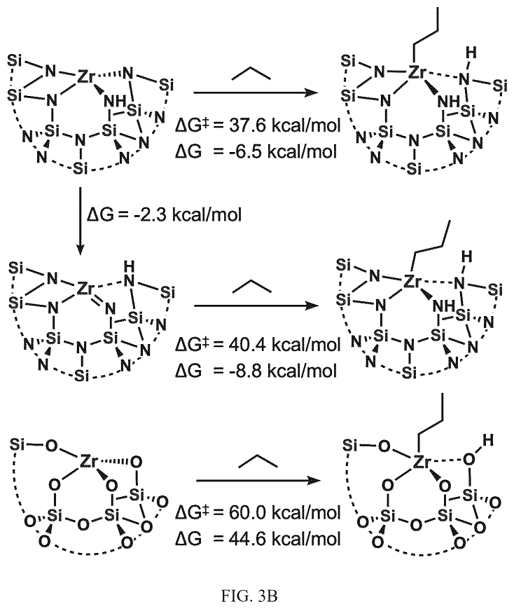

In contrast to this prior work, catalysts described herein are believed to provide, by having bulk nitride surfaces, a range of otherwise inaccessible active site geometries. These additional active sites and active site geometries affords the possibility of neutral lattice nitrogen donors contributing to the inner coordination sphere of the active site, providing for improved performance of heterolytic C—H cleavage in PDH relative to a silica supported homologue. Generally, it is believed there are two reaction pathway possibilities, the mechanism is homologous (heterolytic bond activation across Zr—X (X═O or N) single bond, and the energetic barrier is lower in the Si₃N₄ case because of either the basic nature of the nitrogen, or because of destabilization of the active site because of the rigidity of the surface (or both), or alternatively, the mechanism on the nitride surface could be via the formation of a Zr═N double bond, and then activation of the C—H bond across that zirconium imido group, which would be unique to the nitride surface. thes are depicted in FIG. 3B. The calculations in FIG. 3B also suggest a possible difference in resting state (not guaranteed), where the bond activation is favorable in energy for the nitride surface, but unfavorable for the silica surface.

The catalyst material comprises a support and an active phase and optionally a promotor. The support material comprises a silicon-based material. In particular embodiments, the support comprises Si₃N₄.

The support material described herein has disposed thereon an active phase comprises active phase material for non-oxidative propane dehydrogenation. The active phase may be disposed thereon by vapor or solution phase deposition techniques, including impregnation, incipient wetness impregnation, strong electrostatic adsorption, atomic layer deposition, chemical vapor deposition, etc. For metallation with well defined molecular precursors including orgaometallics the grafting could occur by ligand protonolysis at a Bronsted acid site, ligand abstraction at a Lewis acid site, condensation at the ligand, or electron transfer to a redox functionalized surface. Specifically, active phase material that involves heterolytic C—H bond cleavage across the metal oxide bond. The metal active site could be any transition metallic, or even post transition metals. In one embodiment, first row transition metals may be the active site.

In order to form the active site, organometallic materials may be used. Ligands on metal precursors, in addition to organometallic (carbon based) ligands, could be alkoxides, amides, and in some cases metal halides. While tetrahedral catalyst precursors are utilized in some examples, it is not believed that the catalyst is limited to being formed from organometallics with tetrahedral sites, although it is possible that distortion of the tetrahedral geometry plays a role in the reactivity for Zr. It is believed that the metal that are to form the active site, typically lose 1-2 ligands from the organometallic form in the course of the deposition. Specifically in the case of the Zr that likely means that the pre-catalyst has two remaining carbon ligands. Under reaction conditions, it is further believed that the ligands are lost, either by thermal elimination or after initial reaction with the reagent gasses, and the active catalyst is likely a more highly chelated isolated surface atom/ion.

In certain embodiments, active phase material comprises a metal, such as Cr, Ga, V, Fe, Co, and Zr. In a further embodiment, the active phase materials, when present on the support, specifically comprises a metal ion (rather than elemental form) of Cr, Ga, V, Fe, Co, and Zr. Exemplary catalysts may include metal-ligand complexes with an active metal, such as Cr, Ga, V, Fe, Co, Zr. Thus, some embodiments utilize as an active material organometallic complex; for example, Zr may be utilized in the form of tetrabenzylzirconium. For metal-ligand complexes, the organic ligand may be selected from 1) alkyl groups, including methyl, ethyl, propyl, butyl, neopentyl, benzyl, etc. primary or secondary; 2) aryl (for example a M-Ph group); 3) metal amides (M-NR2, R=H or alkyl, aryl, etc.); 4) metal alkoxide (M-OR R=H or alkyl, aryl, etc.); and 5) Hydrides (M-H).

Some embodiments may further utilize a promotor. A promotor may be utilized to further alter the reaction site electrochemistry. Combinations of Lewis acidic ions and other transition metals can be used to modulate the electronics of the surface and by extension the catalytic reactivity. The promoter could also be a redox active ion that aids in electron storage or electronic tuning of the surface.

Such catalysts may used in a method for non-oxidative propane dehydrogenation. The catalysis may occur in a reactor at a temperature of 400° C. to 750° C., such as 450° C. with an alkane flow rate of depending on the scale of the reactor, such as 5 mL/min of 2% v/v. In addition to the 2% volume, various embodiments may utilize a feed of alkane feedstock any concentration range from ultra-dilute to pure.

### Examples

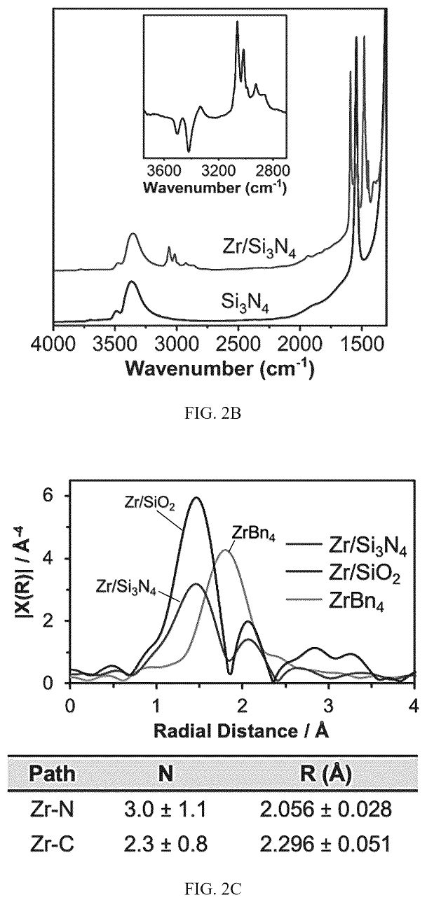

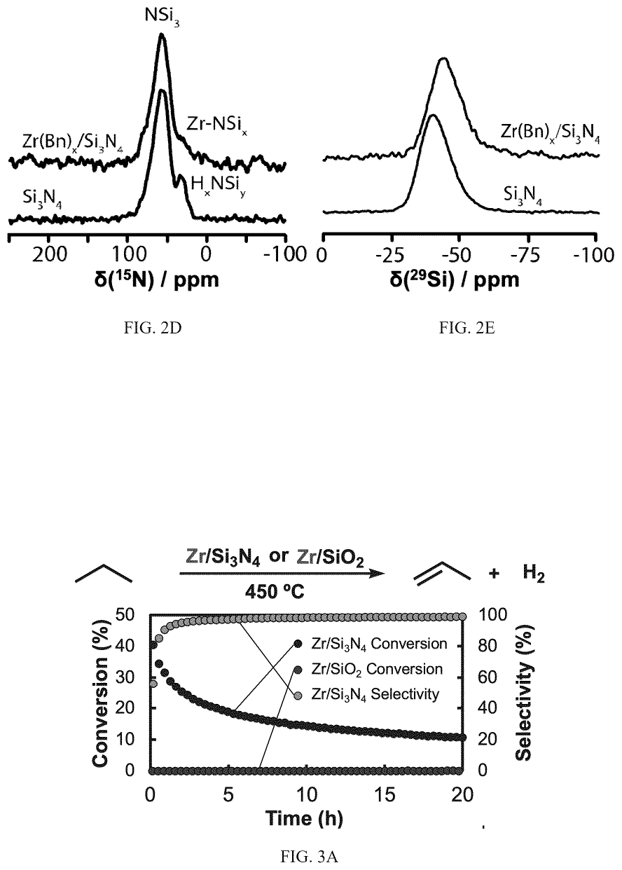

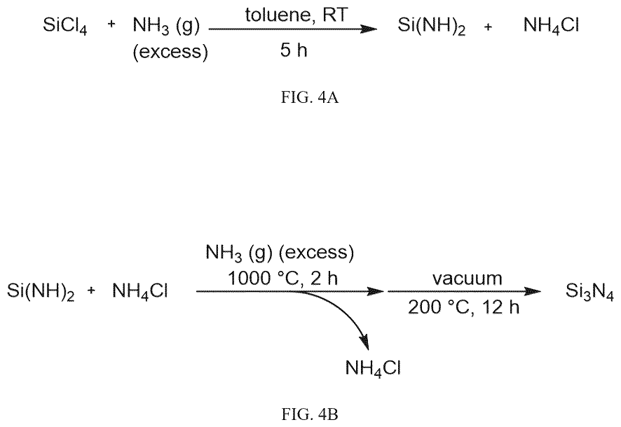

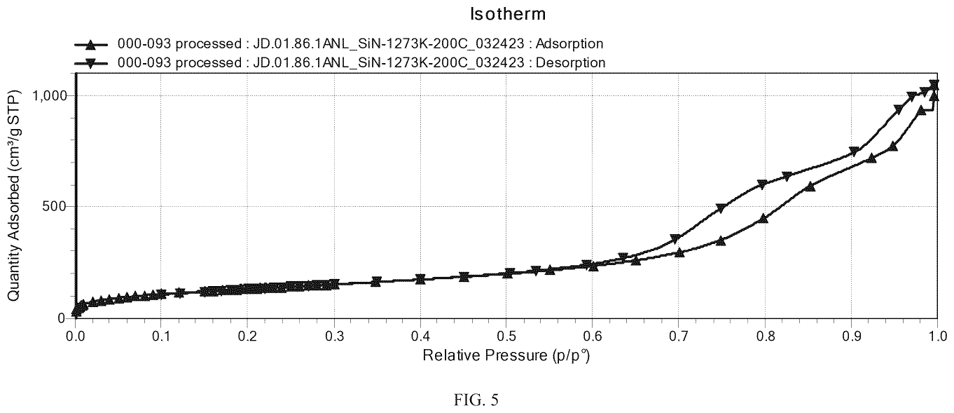

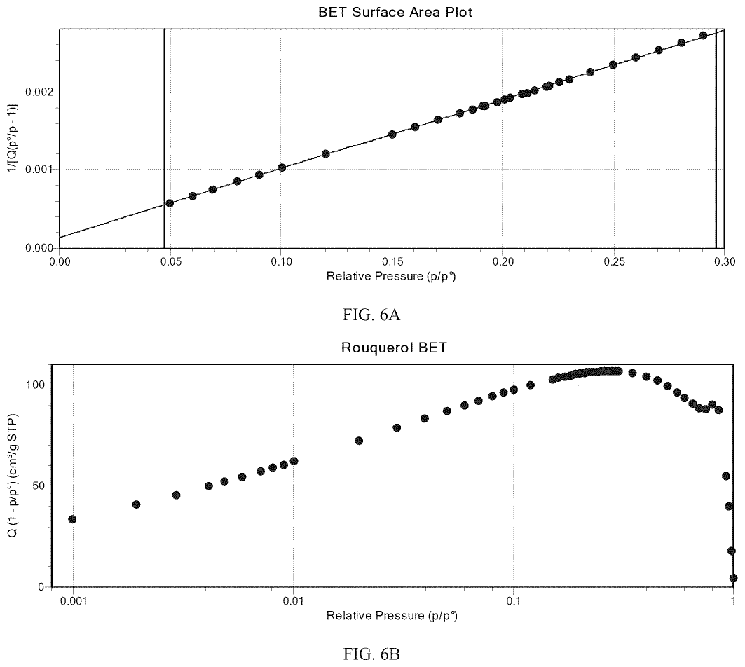

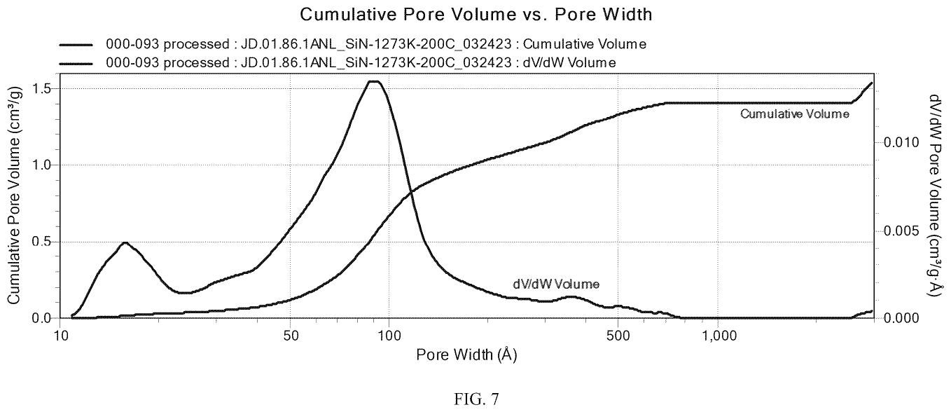

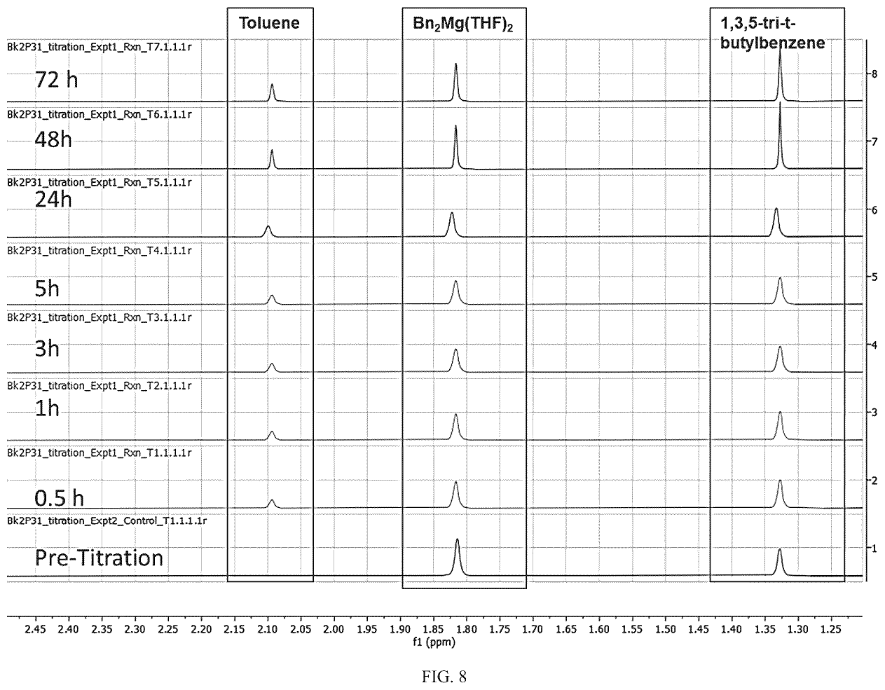

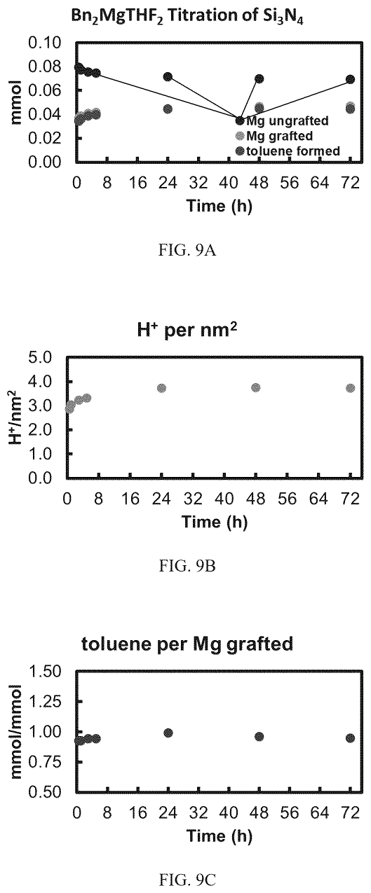

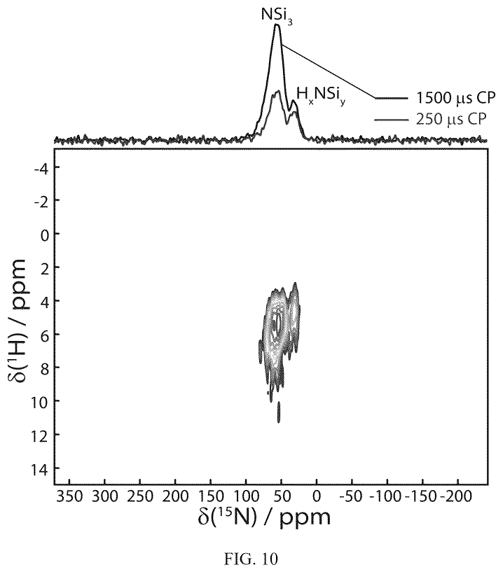

The preparation of high surface area, amorphous silicon nitride was performed using a protocol adapted from Kaskel and coworkers (FIGS. 4A-4B). A silicon tetrachloride precursor was dehalogenated with ammonia generating silicon diimide. The diimide was then converted to silicon nitride through thermal ammoniolysis in a tube furnace at 1000° C. It is noted that the silicon imidonitride could range anywhere from Si(NH)₂ to Si₃N₄. More generally this could be written as Si(_{3-x/4})) (NH)ₓ N(₄₋ₓ). Further, silicon oxynitrides (SiₐOₓN_{y}) (where a is 1 or 3, and x is 0-2 and y is 0, 3, or 4) may also be utilized. Notably, some embodiments utilize removal of labile or weakly absorbed surface species, such as physiosorbed/chemisorbed ammonia, by vacuum activation (<20 mtorr) at 200° C. Brunauer-Emmett-Teller (“BET”) surface area and porosity analysis of the resultant Si₃N₄ revealed a mesoporous material (avg pore size ˜90 Å) with a high surface area (486 m²/g) (FIGS. 5-7). Titration of the surface Bronsted acids using Bn₂Mg(THF)₂ indicated the presence of a density of ˜3.8 reactive acid sites per nm² (FIGS. 8, 9A-9C). Surface functionality was assessed using diffuse reflectance infrared Fourier transform spectroscopy (“DRIFTS”) (FIG. 2B). A broad asymmetric feature appeared at 3360 cm⁻¹ with a shoulder at 3485 cm⁻¹ which are consistent with prior observations of N—H vibrations of —NH₂ symmetric stretching, νₛ(NH₂), at 3535 cm⁻¹ and —NH₂ asymmetric stretching, νₐₛ(NH₂), at 3445 cm⁻¹ overlapping with the ═NH, ν(NH), stretching feature at 3350 cm⁻¹. Additionally, a sharp signal was present at 1588 cm⁻¹ which is consistent with the —NH₂ bending mode, δ(NH₂) (FIG. 2B). Dynamic nuclear polarization (“DNP”) surface-enhanced solid state nuclear magnetic resonance (“NMR”) analysis was performed to further characterize the support surface. The ²⁹Si cross polarization magic angle spinning (“CPMAS”) NMR analysis of the prepared Si₃N₄, revealed a dominant, featureless line at −43 ppm consistent with a SiN₄ site in proximity to a surface amine (FIG. 2E). The DNP-surface enhanced ¹⁵N CPMAS NMR spectrum exhibited two resonances at 57 and 32 ppm from surface Si₃N and amino (Si₂NH and SiNH₂) sites, respectively (FIG. 2D), as confirmed by the latter's faster cross-polarization (FIG. 10).

Having formed the support material, Tetrabenzylzirconium (ZrBn₄) was selected as an exemplar precursor for forming the active material for organometallic reactivity to perform exploratory studies on the Si₃N₄ surface. Previous research has shown that a zirconium modified silica catalyst exhibits negligible activity towards PDH. Therefore, it is believed that any observed catalytic activity for PDH is a result of the novel nitride support. The tetrabenzylzirconium enhanced heterolytic bond activation. In particular, it is believed that the nitride support enhances the isolated zirconium active site (or in general, the active site for active materials) towards C—H bond cleavage and enable PDH activity.

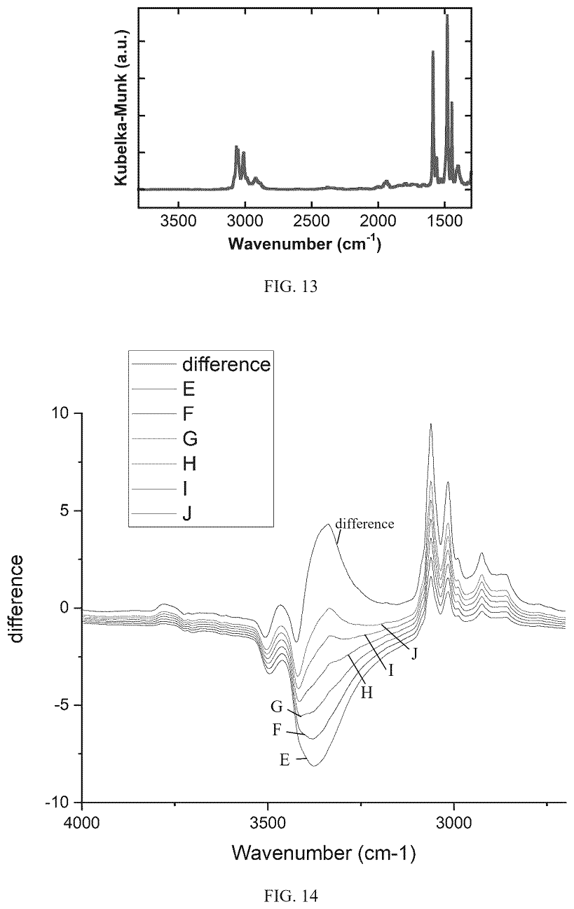

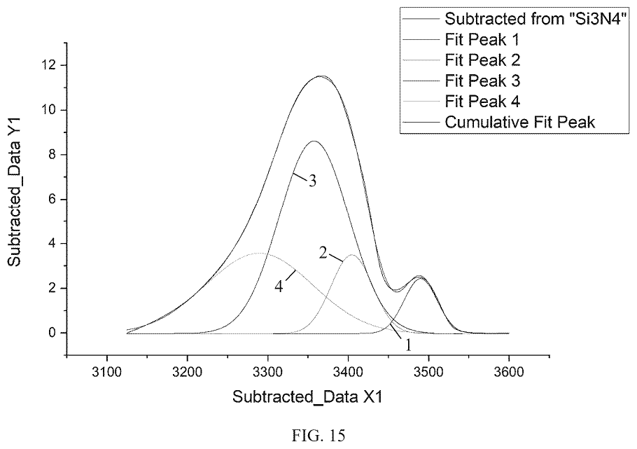

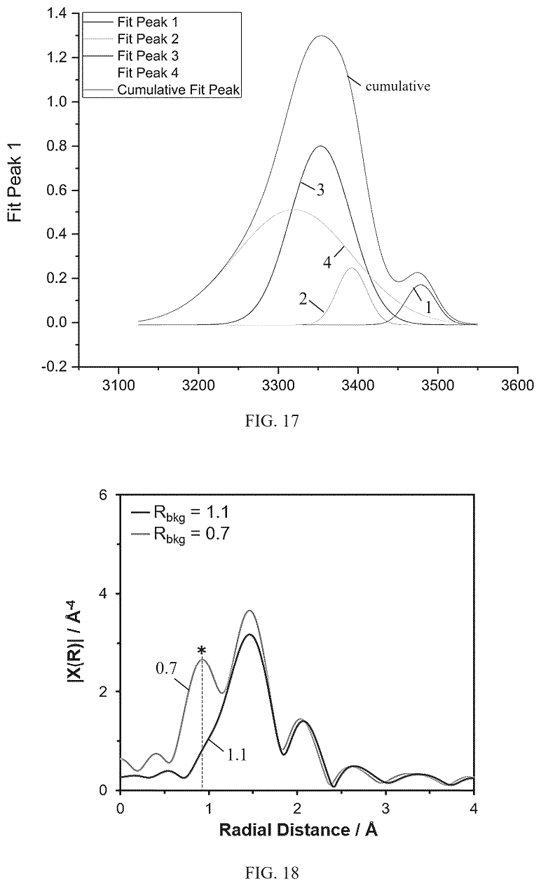

Preparative scale grafting with 600 mg of silicon nitride and 0.75 mmol of Tetrabenzylzirconium afforded Zr/Si₃N₄ with a Zr loading of 7.5 wt % determined by inductively coupled plasma-optical emission spectroscopy (“ICP-OES”) (Table 1). Analysis of the preparative scale grafting experiment by DRIFTS revealed an attenuation of the δ(NH₂) bending mode and the presence of aromatic C—C and C—H stretching features consistent with those of a zirconium bound benzyl ligand (FIGS. 2B, 13). Comparison of contributions from NH and NH₂ to the N—H stretching region before and after grafting indicated a decrease in NH₂ relative to NH after grafting, which suggested a preference for protonolysis at the NH₂ sites (FIGS. 2B, 14-17).

TABLE 1
ICP-OES and elemental analysis results.

| Sample | Element | % wt |
|---|---|---|
| Si₃N₄ | Silicon | 51.8 |
| Si₃N₄ | Nitrogen | 39.73 |
| Zr/Si₃N₄ | Zirconium | 7.56 |
| Zr/SiO₂ | Zirconium | 3.48 |

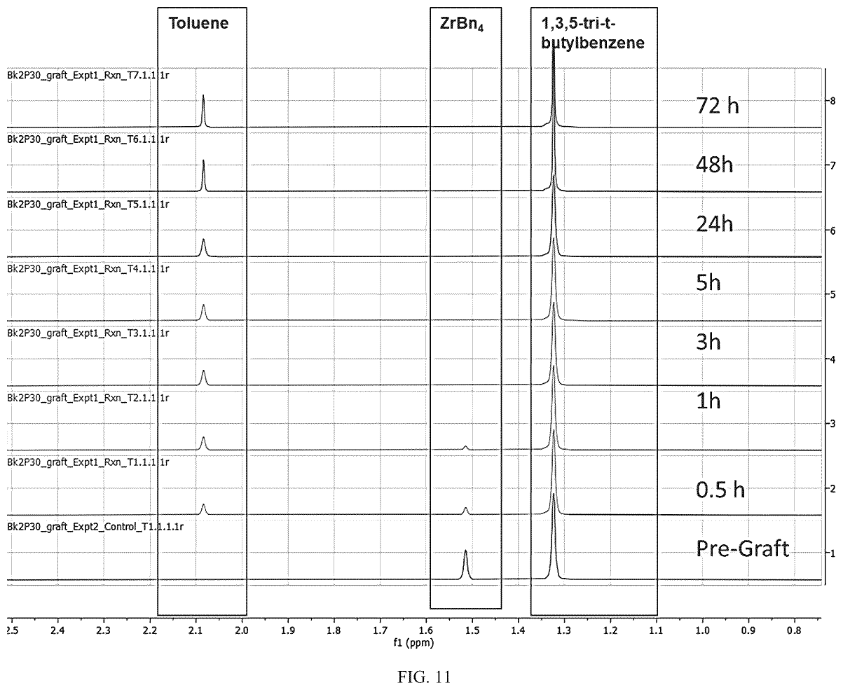

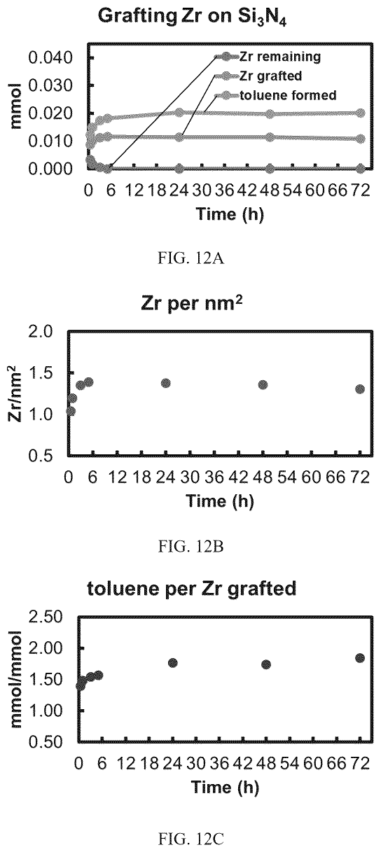

Chemisorption of ZrBn₄ on Si₃N₄ was conducted in benzene-d₆ at room temperature and monitored periodically over 72 h by ¹H NMR spectroscopy (FIGS. 11, 12A-12C). ZrBn₄ was no longer detectable after 5 hours, affording Zr/Si₃N₄ with an approximate surface density of 1.5 Zr/nm². Examination of the evolution of toluene over time suggests that approximately two benzyl ligands are protonolyzed in a two-step process, with the protonolysis occurring rapidly, presumably with the initial chemisorption, followed by a slower protonolysis of a second ligand from a metastable monopodal species.

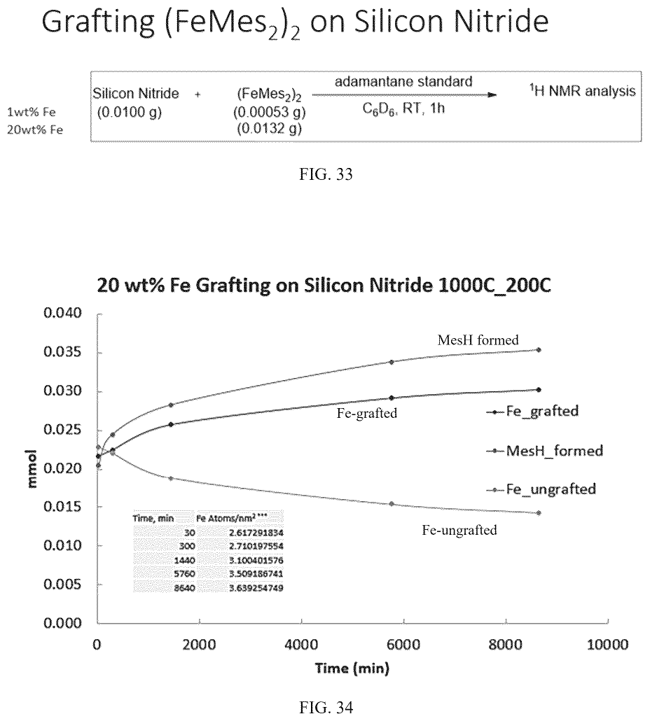

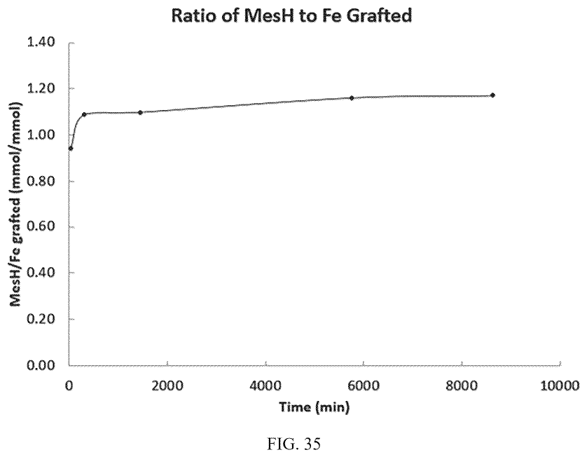

Another embodiment relates to the grafting of iron onto a silicon nitride support. FIG. 33A illustrates a process for foming grafted (FeMes₂)₂ on a silicon nitride substrate, specifically for NMR analysis. FIG. 34 is the results from ¹H NMR analysis of the supernatant following addition of a solution of (FeMes₂)₂ in C₆D₆ to Si₃N₄ pre-soaked in C₆D₆ in a J. Young NMR tube. Plot showing the amount (mmol) of (FeMes₂)₂ remaining ungrafted, (FeMes₂)₂ consumed by grafting, and mesitylene over the course of 150 h. FIG. 35 is a graph of the ratio of MesH to Fe (grafted) over time. Initial reaction, at the 20% Fe level at least, initially favors the grafting of Fe but quickly shifts to favor slightly the formation of MesH grafting.

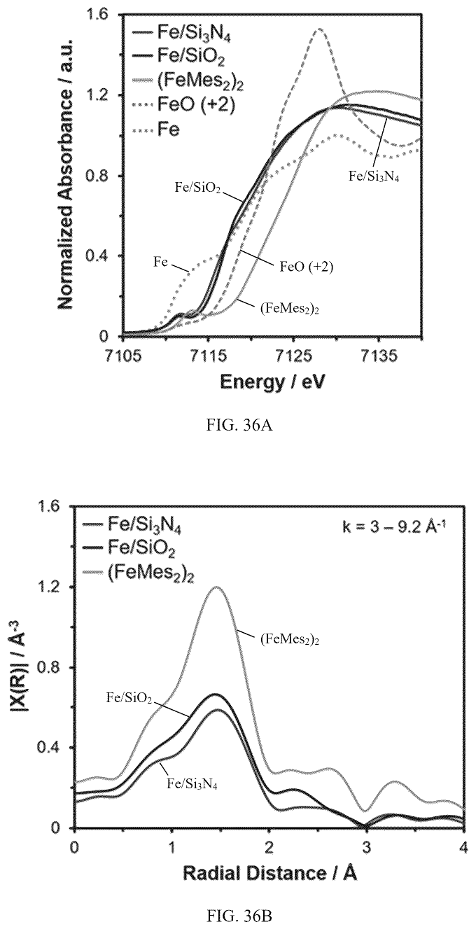

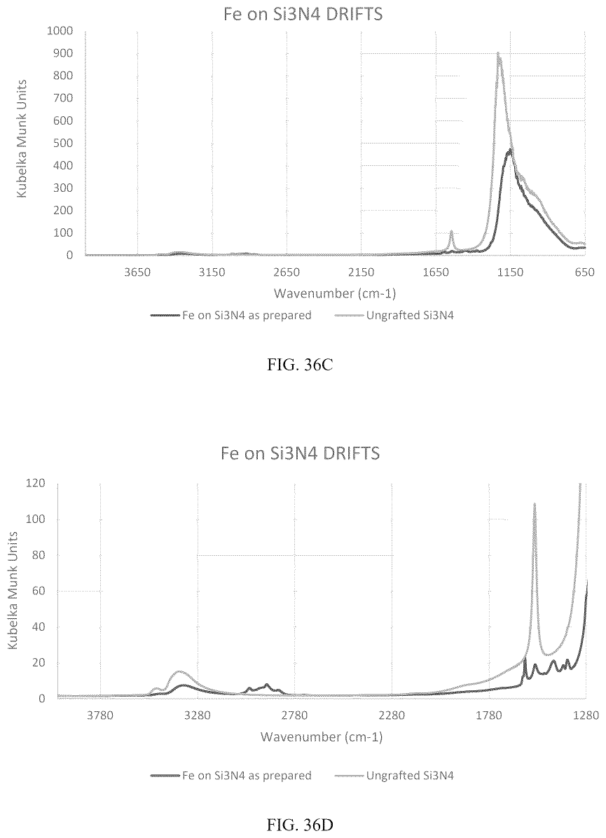

FIG. 36A is graph of x-ray absorption spectroscopy data (XANES) showing normalized absorption versus energy for various materials including iron on silica, iron on silicon nitride, (FeMes₂)₂, FeO and iron. FIG. 36B is EXAFS data indicating the radial distance of the iron on silica, iron on silicon nitride, and (FeMes₂)₂. FIG. 36C provides a further characterization of the grafted and ungrafted silicon nitride by DRIFTS over a 3650 to 650 wavelength span indicating a large peak below 1250 and peaks associated with NH₂, NH, and OH presence. FIG. 36D provides a further characterization of the grafted and ungrafted silicon nitride by DRIFTS, focused at the wavelengths above the peak seen in FIG. 36C, showing the peaks associated with NH₂, NH, and OH presence. The DRIFT data shows evidence of the formation of OH, NH, and NH₂ due to the grating of the iron, providing nitrogen near the metal catalytic site for energetically favorable catalysis.

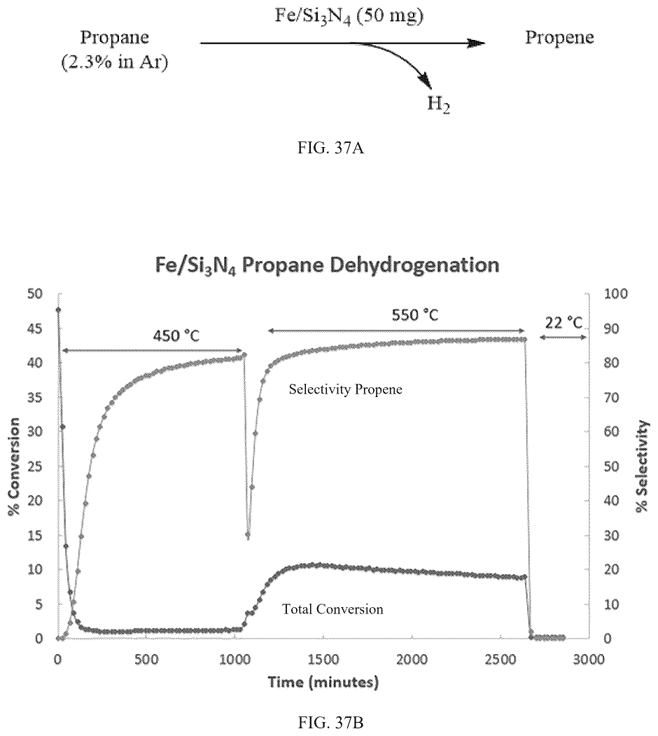

FIG. 37A illustrates the propane dehydrogenation process for Fe/Si₃N₄ utilized for the results data shown in FIG. 37B. FIG. 37B shows the results, in both percent conversion and percent selectivity, over time for experiments for propane dehydrogenation of FIG. 37A at both 450° C. and 550° C. The process for the data shown in FIG. 37B utilized heating under helium gas environment with a 5 ml/min propane flow rate. The initial temperature was held at 450° C. and then ramped to 550° C. as show, with a final cooking to 22° C. Selectivity increased over time to approach a stead state at both 450° C. and 550° C., with the latter showing improved conversion rates. The room temperature reaction indicates little to no conversion. These results suggest a higher reactivity at a lower temperature with comparable selectivity when contrasted with iron on silica catalyst materials.

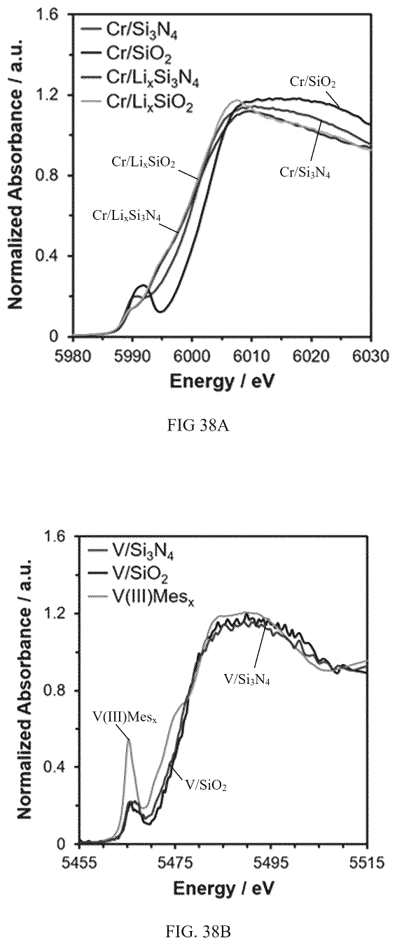

Another embodiment relates to the grafting of chromium or vanadium onto a silicon nitride support. FIG. 38A is graph of XANES data showing normalized absorption versus energy for various materials including Cr on silica, Cr on silicon nitride, CrLiₓSi₃N₄, and CrLiₓSiO₂. FIG. 38B is graph of XANES data showing normalized absorption versus energy for various materials including V on silica, V on silicon nitride, V on silica, and V(III) Mesₓ.

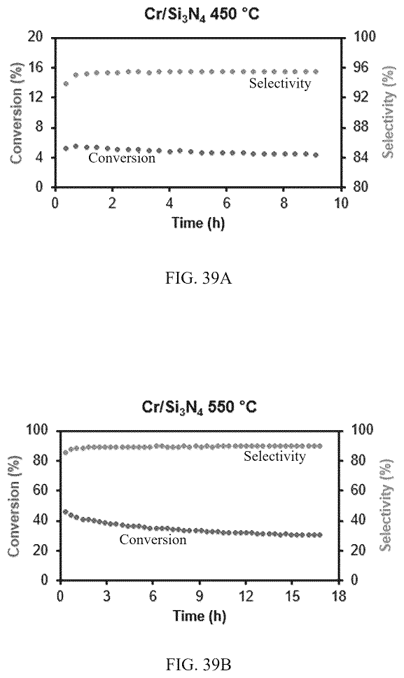

FIG. 39A shows the results, in both percent conversion and percent selectivity, over time for experiments for propane dehydrogenation at both 450° C. FIG. 39A shows the results, in both percent conversion and percent selectivity, over time for experiments for propane dehydrogenation of FIG. 37A at 550° C. Selectivity and conversion rate are notably higher at the higher temperature.

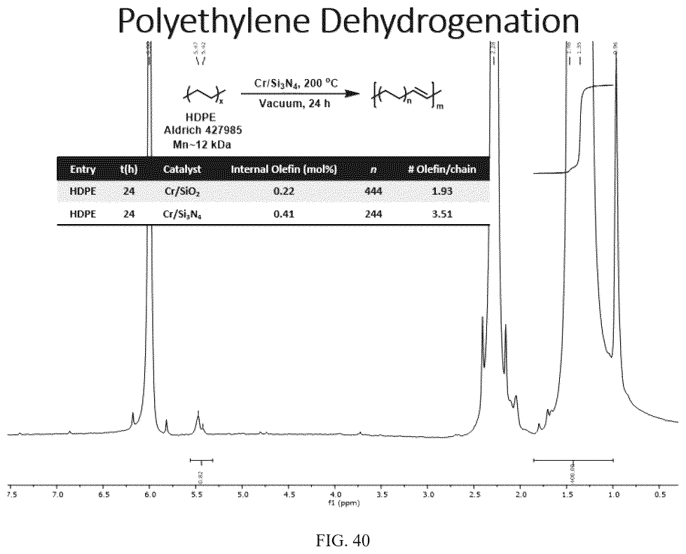

FIG. 40 illustrates the polyethelyene dehydrogenation process for Cr/Si₃N₄ as well as the resultant comparison of the dehydrogenation for the silicon nitride and silica substrates with the Cr grafted on.

### Analysis of Example Catalyst.

Solid state ¹H, ¹³C, ¹⁵N, and ²⁹Si NMR analysis was then performed to probe the structure of Zr/Si₃N₄. A shift was observed in the surface ²⁹Si NMR resonance to −47 ppm (FIG. 2E), closer to that expected from bulk Si₃N₄ sites (−49 ppm) due to the consumption of the NH₂SiN₃ sites (−43 ppm). In agreement with this observation, the DNP-enhanced ¹⁵N CPMAS NMR spectrum (FIG. 2D) revealed the consumption and shifting of the amino resonance. Zr metal-induced ¹⁵N shifts in Zr(NMe₂)ₙ/SiO₂ have been reported to be +9 ppm, which suggest that the ¹⁵N low-frequency shoulder contains signals from both unreacted amino nitrogens and N—Zr sites. A DNP-enhanced ¹³C{¹H}HETCOR spectrum (FIG. 2F) of Zr/Si₃N₄ was collected to assess the nature of residual benzyls on the surface. A signal at 131 ppm correlated with aromatic protons consistent with those from benzyl ligands. The ¹³C NMR signal at 68 ppm correlates to 1H spins resonating at 2.4 ppm, consistent with the methylene —CH₂ in a Zr-benzyl bond suggesting benzyl ligand was retained after grafting.

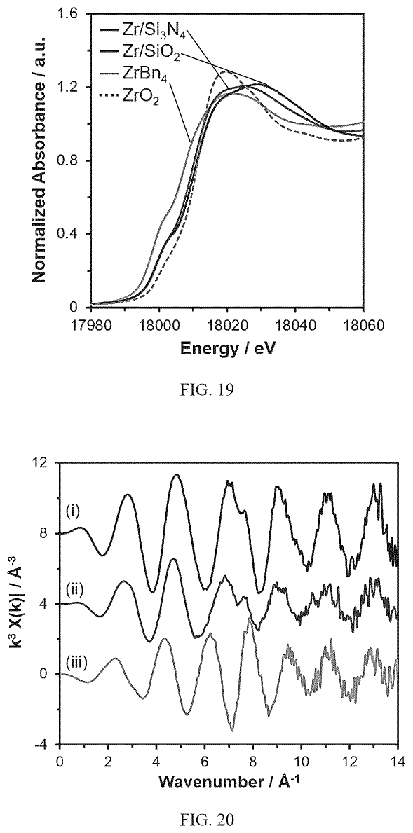

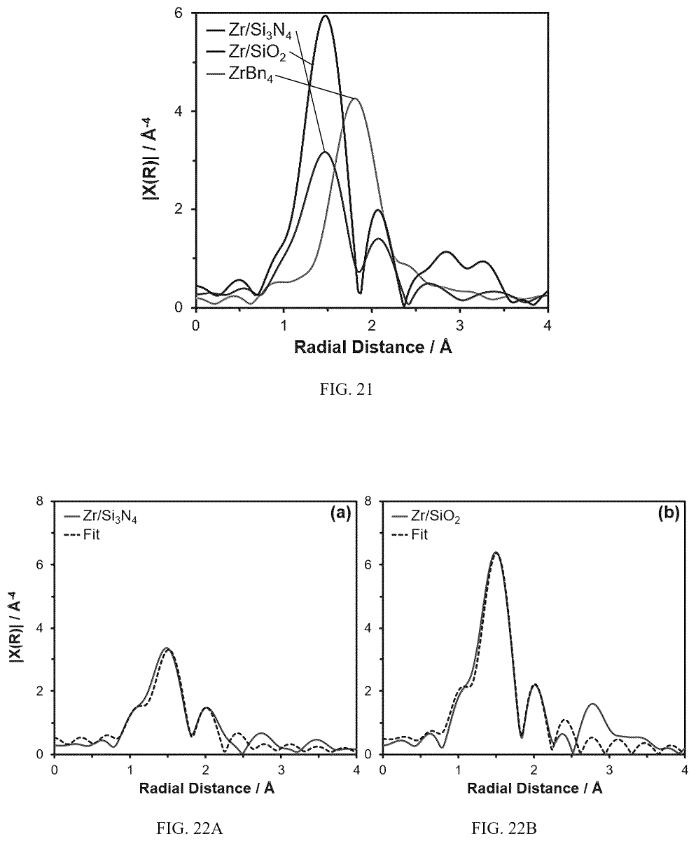

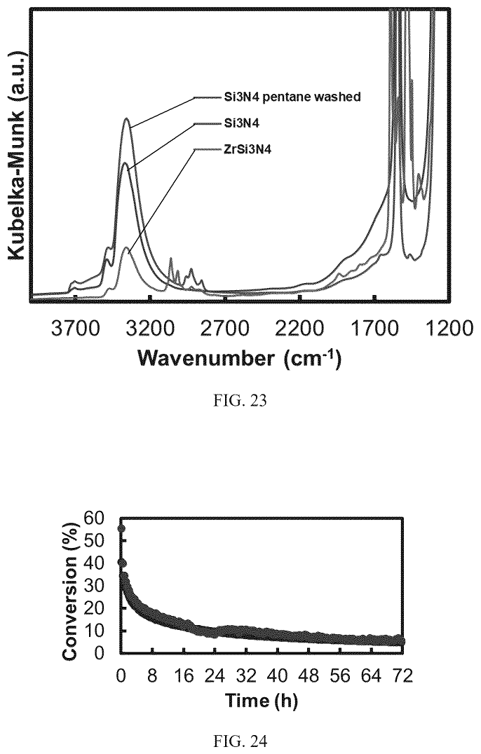

X-ray absorption spectroscopy (“XAS”) analysis was also employed to assess the structure of the supported Zr on silicon nitride as well as a prepared homologue on silica (Zr/SiO₂) (FIGS. 2C, 18-21, 22A-22B). Qualitative comparison of the Zr K-edge with ZrBn₄ and ZrO₂ was consistent with a Zr(IV) oxidation state of Zr/Si₃N₄ and Zr/SiO₂ (FIG. 19). Fitting of the extended X-ray absorption fine structure (“EXAFS”) of Zr/Si₃N₄ was described by a first shell Zr—N coordination number of 3.0±1.1 and a Zr—C coordination number of 2.3±0.8 at distances of roughly 2.06 Å and 2.30 Å, respectively (FIGS. 2C, 2I, 22A-22B and Table 2). The elongated radial component (Zr—C) of the first coordination shell gives rise to the scattering feature near 2.1 Å in the EXAFS of both supported Zr species (FIG. 2C). For Zr on both supports, there was no indication of neighboring Zr atoms suggesting that Zr forms atomically dispersed species on the surface of both Si₃N₄ and SiO₂.

TABLE 2
Zr K-edge EXAFS fitting results for Zr/Si₃N₄ and Zr/SiO₂.

| | | | | σ² | | R- |
|---|---|---|---|---|---|---|
| Sample | Path | N | R (Å) | (×10⁻³Å²) | ΔE₀ (eV) | factor |
| Zr/Si₃N₄ | Zr—N | 3.0 ± 1.1 | 2.056 ± 0.028 | 5.1 ± 4.1 | 5.6 ± 2.8 | 0.0224 |
| | Zr—C | 2.3 ± 0.8 | 2.296 ± 0.051 | | | |
| Zr/SiO₂ | Zr—O | 3.7 ± 0.9 | 1.993 ± 0.014 | 3.6 ± 2.5 | 5.3 ± 2.0 | 0.0076 |
| | Zr—C | 2.0 ± 0.8 | 2.289 ± 0.051 | (5.1) | | |

Values in parentheses were set. S₀² was set to the value fit for the Zr reference foil (S₀² = 0.81 ± 0.08). k^{N} (N = 1, 2, 3), k = 3-12 Å⁻¹, R = 1.1-2.4 Å Δk = 0.1.

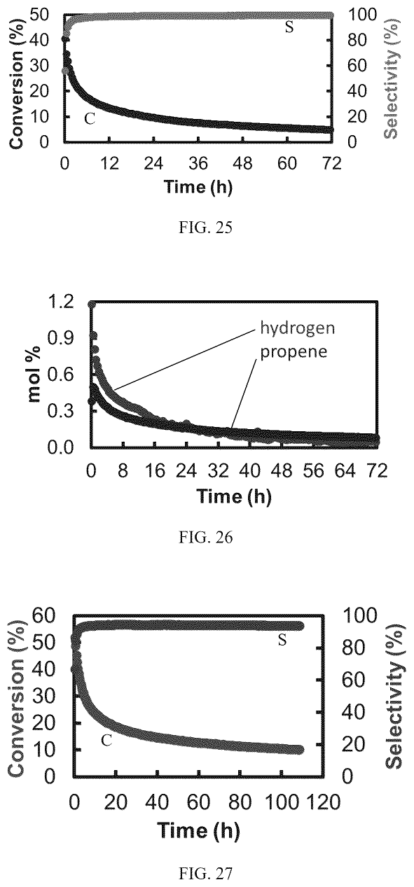

Performance of example catalyst The performance of Zr/Si₃N₄ for PDH was initially assessed in a plug flow reactor at 450° C. with a flow rate of 5 mL/min of 2% v/v propane. Under these conditions an initial burst of reactivity with low selectivity was observed. This initial burst of reactivity may be associated with formation of transient hydride species. In one embodiment, the catalyst may be pre-treated with hydrogen to minimize this initial reactivity burst. That initial burst transitions to higher selectivity, approaching 99%, likely through a gradual deactivation, for the generation of propene over 72 hours on stream (conversion and selectivity of 35% and 85% at 0.5 h; 25% and 95% at 2 h; 19% and 97% at 5 h; 10% and 99% at 24 h; and 5% and 99% at 72 h) (FIGS. 3A, 24-25). The reaction also proceeds with a high carbon balance (Cₒᵤₜ/Cᵢₙ), with ratios of 0.98 at 1.0 h and >0.99 at 72 h (FIG. 26). In contrast, under the same conditions, as expected based on prior PDH studies for Zr active material, the silica supported homologue (Zr/SiO₂) did not generate significant quantities of propene (conversion <0.1%) (FIG. 3A).

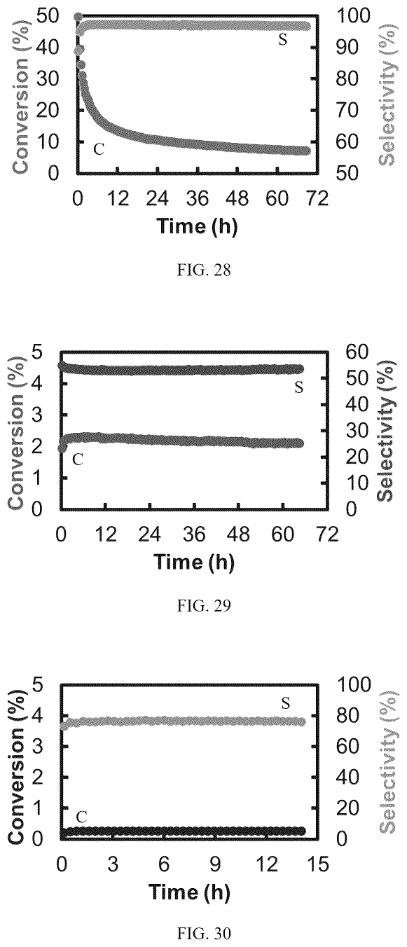

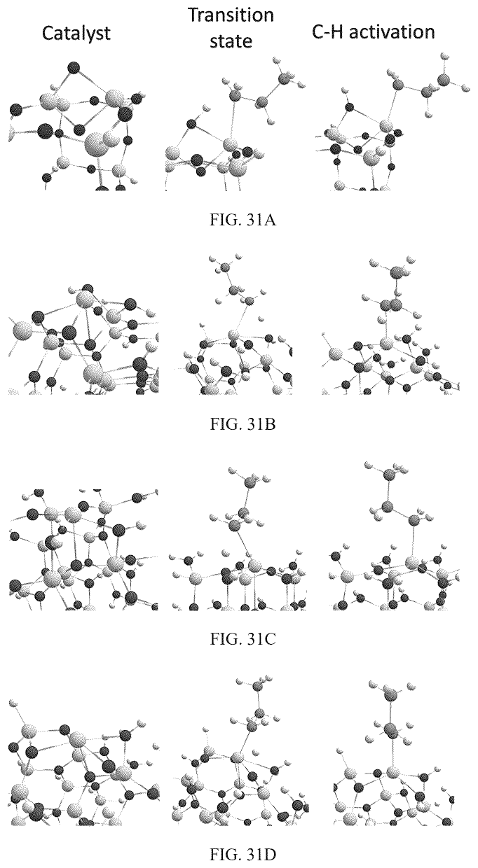

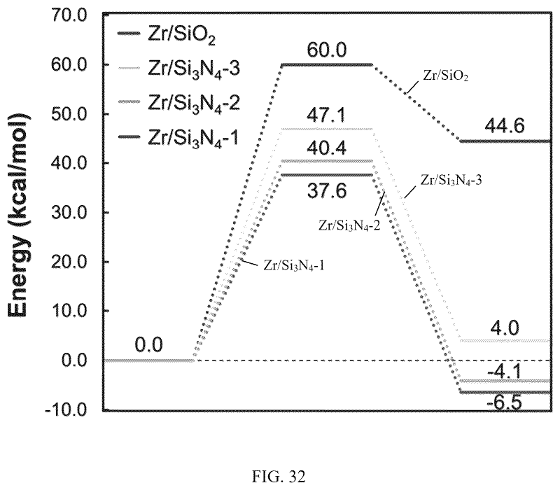

The same materials were then utilized in a reaction was then performed at 550° C. At this higher temperature, a higher equilibrium conversion is achievable. Further, this temperature allows for more direct comparisons to other SOMC PDH catalysts (see FIGS. 27-30). At this elevated temperature and with the flow rate increased to 20 mL/min a similar reaction profile was observed with an initial activity of 137 gₚᵣₒₚₑₙₑ mol_{Z}_{ᵣ}⁻¹ h⁻¹ and selectivity for propene reaching >97% for the duration of 68 hours on stream (FIG. 28). It is noted that the unmetallated Si₃N₄ support exhibits low conversion of propane (<2.5% with ˜53% selectivity) at 550° C. (FIG. 29).

When the silica supported zirconium catalyst was implemented at this elevated temperature, a maximum conversion of 0.27% was observed with 78% selectivity (FIG. 30), further confirming the enhancement in activity and selectivity engendered by the nitride support. Quantitative comparison with previously reported SOMC catalysts on silica is complicated by differences in experimental conditions, principally in the concentration of the gas feed and maximum productivities outside of the differential conversion regime. The Cr and Co catalysts, with a 20% propane feed, achieved productivities of 832 and 525 gₚᵣₒₚₑₙₑ mol_{Metal}⁻¹ h⁻¹ at 72% and 92% selectivity respectively, while the Ga, Fe and V catalysts, reported with 2-3% propane, achieved productivities of 63, 46, and 10 gₚᵣₒₚₑₙₑ mol_{Metal}⁻¹ h⁻¹ at 97%, 69% and 94% selectivity respectively. The Zr/Si₃N₄, surpasses the three catalysts (Ga, Fe, V) reported under similar partial pressures of propane, and given that the turnover limiting step for most SOMC single site dehydrogenation is heterolytic C—H bond activation (e.g., first order in propane), the Zr/Si₃N₄ likely compares favorably to the Cr and Co catalysts supported on silica as well.

Having observed a significant catalytic enhancement of the silicon nitride supported organozirconium complex relative to the silica supported analogue, a preliminary computational analysis by density functional theory (“DFT”) was performed to investigate differences in energetics of the putative key C—H activation mechanism between the two catalytic systems (paragraph [0066]). This investigation evaluated two classes of potential structures on the silicon nitride surface (FIG. 3B), generated after the transfer of hydrides to the surface following the transient initial phase of catalysis. One structure features a distorted Zr structure with four X-type nitrogen donors, and one elongated L-type lattice nitrogen donor, while the other structure features a Zr—N metal imido motif generated from proton transfer between inner sphere nitrogen donors. The barrier to heterolytic bond activation across the Zr—N single bond was found to be 37.6 kcal/mol, with the energetics of the process being exergonic (ΔG=−6.5 kcal/mol). Isomerization of the Zr on Si₃N₄ model to the Zr—N imido structure was found to be slightly favored (ΔG=−2.3 kcal/mol), and the barrier for heterolytic C—H activation across the Zr═N double bond was found to be 40.4 kcal/mol. Thus, there is a net difference in the simulated barriers for C—H activation between the Zr—N amido and imido groups (ΔΔ^{†}) of 0.5 kcal/mol. Based on this value, both pathways are potentially catalytically relevant given the range of possible local geometries on the amorphous surface. In contrast, heterolytic bond activation at a similar Zr/SiO₂ site was calculated to have a significantly higher activation barrier (ΔG^{†}=60.0 kcal/mol) and was highly endergonic (ΔG=44.6 kcal/mol). These dramatic differences are hypothesized to originate from the basic nature of the amido ligand and the loss of energy in the oxide system due to the oxophilicity of the early transition metal active site. In addition to these effects, the initial Zr structure on the Si₃N₄ surface may be destabilized due to a decreased capacity for the nitride surface to reorganize after ligand transfer to the surface as a consequence of the more highly connected Zr—NSi₂ group relative to the single surface binding site of a Zr—OSi motif. The decreased capacity to reorganize may result in more strained and distorted Zr geometries, in turn leading to lower bond activation barriers and energies.

These results indicate that high surface area amorphous silicon nitride is suitable for chemisorption of organometallic precursors, and the nitride surface is indeed capable of significantly enhancing catalytic activity as demonstrated in the case of Zr catalyzed propane dehydrogenation. The silicon nitride supported organozirconium catalyst outperforms the silica supported analogue in propane dehydrogenation with a dramatic improvement in conversion and selectivity, observed both at 550° C. and the relatively mild temperature of 450° C. The improved performance of the silicon nitride supported catalyst may plausibly be attributed to improved heterolytic C—H bond cleavage through increased Lewis basicity of the inner sphere metal amide ligand relative to the siloxide donor on silica.

### Experimental Data.

Unless noted otherwise, reagents were purchased commercially and without further purification. Anhydrous solvents were filtered through activated alumina and stored over 4 Å molecular sieves under inert nitrogen or argon atmosphere. All moisture and air sensitive experiments were performed in an MBraun inert atmosphere N₂ or Ar glovebox or using Schlenk techniques. ZrBn₄ was either purchased from Strem Chemicals and purified by recrystallization in a toluene at −30° C. or synthesized from ZrCl₄ and BnMgCl following a procedure adapted from the literature. The MgBn₂(THF)₂ was prepared following a procedure adapted from the literature.

### Experimental Methods

N₂ Physisorption. Nitrogen gas physisorption measurements were collected at 77° K on a Micromeritics ASAP 2020 Adsorption Analyzer. Isotherm data was processed on Micromeritics Microactive V.6.00 software for Brunauer-Emmett-Teller (“BET”) surface area and porosity analysis.

Diffuse Reflectance Fourier Transform Infrared Spectroscopy (“DRIFTS”). DRIFTS analysis was performed using a Thermo Scientific Nicolet iS50 FTIR spectrometer. The MCT-A detector was pre-cooled to 77° K prior to background and sample data collection. Samples were prepared for DRIFTS analysis by loading into an air free ex situ cell with ZnSe windows. Sample backgrounds were collected using spectroscopic grade KBr.

¹H Nuclear Magnetic Resonance (“NMR”) Spectroscopy. ¹H NMR data was collected on a Bruker NMR spectrometer (600 MHz). Air free samples were prepared in capped J. Young tubes in an inert nitrogen atmosphere glovebox. Spectra were processed using Mnova by Mestrelab and referenced to the residual solvent signal or internal standard.

Flow Reactor Catalysis. Samples were weighed (50 mg) into a U-shaped quartz reactor tube sandwiched between two quartz wool plugs. The quartz tube was sealed with two-way and three-way valves fitted with ultra-torr fittings to minimize air exposure when transferring the catalysts out of the glovebox. The sealed quartz tube was mounted vertically to a Zeton Altamira (Model AMI-100) characterization system with a vertical furnace and modified with a supplementary (Brooks 5850E Series) for multi-gas flow. Reaction temperatures were monitored with an Omega K-type thermocouple fitted directly to the quartz tube surface centered on the catalyst bed. Gas lines were purged with helium (Airgas, ultra-high purity grade) prior to flowing over the catalyst bed. Samples were heated to the desired temperature (+5° C./min) under helium flow (5 mL/min). Once at the target temperature, the helium line was switched off and a 2-2.3% propane (Airgas, balance argon) line was opened to the sample. Helium and argon gas levels were monitored by a residual gas analyzer (Stanford Research Systems QMS200 Gas Analyzer). Once helium was purged out and argon stabilized, the product gas analysis from catalysis was performed using an Agilent 7890B GC system equipped with FID (hydrocarbon analysis) and TCD (hydrogen analysis) detectors.

X-ray Absorption Spectroscopy (“XAS”). XAS measurements were conducted at the Advanced Photon Source at Argonne National Laboratory at the 10BM beamline which uses a bending magnet source and water-cooled Si(111) double-crystal monochromator. The beam intensity was detuned to 50% of the peak for harmonic rejection. During sample measurements at the Zr K-edge, spectra of the Zr metal foil were collected simultaneously and spectra were calibrated by setting the energy of the zero-crossing of the second derivative spectra for the metal to 17,995.88 eV. Processing of all spectra including normalization, background subtraction, calibration, and extended x-ray absorption fine structure (“EXAFS”) fitting were completed using the Demeter/Athena/Artemis suite of software.

Ex-situ samples were prepared without air exposure within a N₂-filled glovebox. All samples were prepared as mixtures by grinding with a mortar and pestle with polyvinylpolypyrrolidone (“PVPP”) in a ratio to optimize the Zr absorption edge step and to form a sufficiently sturdy pellet for analysis. Samples were then pressed into self-supporting wafers using a pellet press and loaded into a four-sample holder and covered with Kapton tape. The holders were further sealed within stainless steel, Kapton windowed, holders that sealed with an O-ring to prevent air exposure. At the beamline, samples were transferred to a displex cryostat and measured at temperatures less than 100° K to reduce the potential for beam damage. During measurements, there was no indication of beam damage or oxidation of the samples over the course of several measurements in a 2-hour period.

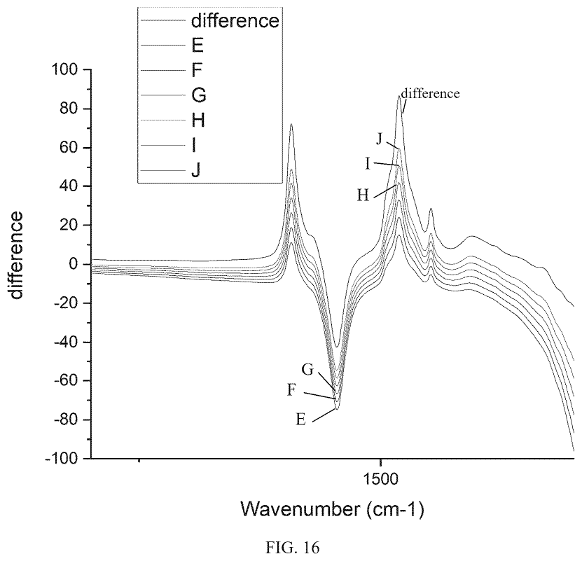

During spectra processing for the Zr samples measured herein, influences of the atomic X-ray absorption fine structure (“AXAFS”) had non-negligeable influences to the oscillatory XAFS structure above the metal edge, producing peaks lying in the low-R range of the EXAFS spectra (˜1 Å or less, FIG. 16). Various values of the R_{bkg} background removal parameter in Athena, specifying the value of R (in A) for which data is removed from the absorption spectrum, were considered to reduce the influence of the atomic background on the EXAFS. As shown in FIG. 16, a R_{bkg} value of 1.1 versus 0.7 Å reduces the contribution from the AXAFS in the spectra, although it has a minor influence on the intensity of the first shell coordination peak near 1.5 Å in the magnitude of the Fourier transform.

Inductively Coupled Plasma-Optical Emission Spectroscopy (“ICP-OES”) Metal Content Analysis and Elemental Analysis. Samples for ICP-OES and elemental analysis (“EA”) were shipped to Galbraith Laboratories at 2323 Sycamore Dr, Knoxville, TN 37921 for analysis. Zr/Si₃N₄ and Zr/SiO₂ were air exposed for several hours to passivate the pyrophoric samples prior to shipping. A negligible change in mass was observed after passivation. ICP-OES was performed on Si₃N₄ to assess Si content, and Zr/SiO₂ and Zr/Si₃N₄ to assess Zr content. EA was performed on Si₃N₄ to assess N content.

DNP Surface-Enhanced NMR. DNP surface-enhanced NMR experiments were performed using a Bruker AVANCE III 400 MHz/264 GHz MAS-DNP NMR spectrometer equipped with a 3.2 mm low-temperature triple-resonance magic-angle spinning (“MAS”) probe. Samples were impregnated with a 16 mM solution of the TEKPol polarizing agent in dry perdeuterated 1,1,2,2-tetrachloroethane in a glovebox and transported in a sealed vial to the nitrogen atmosphere of the NMR probe. All experiments made use of a 2.5 μs ¹H excitation pulse, cross polarization (“CP”), and a 4.5 s recycle delay. ¹⁵N CPMAS spectra were acquired with a 1.5 ms CP contact time, unless otherwise stated. Spectra acquired on the bare support were obtained in 1024 and 2048 scans, the latter being for a spectrum acquired with a 250 μs contact time, and 15,336 scans for the Zr/Si₃N₄ pre-catalyst. The ¹⁵N{¹H}HETCOR spectrum utilized FSLG homonuclear ¹H decoupling and 32 t₁ increments of 98 s, each consisting of 320 scans. ²⁹Si CPMAS spectra were acquired using a 2 ms contact time and 256 and 1200 scans for the Si₃N₄ and Zr/Si₃N₄ materials. The ¹³C{¹H}HETCOR spectrum mirrored the parameters used for the ¹⁵N experiment, with a greater number of t₁ increments (48) being used together with a 250 s contact time and 512 scans.

Bn₂Mg(THF)₂ Titration of Si₃N₄. In an inert nitrogen atmosphere glovebox, Si₃N₄ (0.0150 g) and 500 μL benzene-d₆ was added to a J. Young NMR tube. A stock solution of Bn₂Mg(THF)₂ (0.1690 g, 0.48 mmol), tri-tert-butylbenzene (0.0124 g, 0.050 mmol), and benzene-d₆ was prepared in a 2.00 mL volumetric flask. A 500 μL aliquot of stock solution was added to the NMR tube. The solution was stirred by mechanical rotation of the NMR tube at 10 rpm. Prior to analysis at each timepoint, the sealed NMR tube was centrifuged to isolate the supernatant. A control experiment was prepared with the same procedure but without addition of Si₃N₄.

NMR Analysis of ZrBn₄ Chemisorption on Si₃N₄. In an inert nitrogen atmosphere glovebox, Si₃N₄ (0.0150 g) and 500 μL benzene-d₆ was added to a J. Young NMR tube. A stock solution of ZrBn₄ (0.0231 g, 0.051 mmol), tri-tert-butylbenzene (0.0104 g, 0.042 mmol), and benzene-d₆ was prepared in a 2.00 mL volumetric flask. A 500 μL aliquot of stock solution was added to the NMR tube. The solution was stirred by mechanical rotation of the NMR tube at 10 rpm. Prior to analysis at each timepoint, the sealed NMR tube was centrifuged to isolate the supernatant. A control experiment was prepared with the same procedure but without addition of Si₃N₄.

### Preparation of Starting Materials and Catalysts.

Preparation of Silicon Nitride. Inside an inert nitrogen atmosphere glovebox, a 500 mL Schlenk flask with side arm was charged with 96 mL toluene and 4 mL SiCl₄ and a stir bar. The flask was then sealed and attached to a Schlenk line. The side-arm was purged via nitrogen and vacuum cycles. Under nitrogen flow the flask stopper was replaced with a rubber septum fitted with two ¼ inch stainless steel tubes serving as a gas inlet and a gas exhaust line. The gas inlet was pre-purged with nitrogen gas prior to placing on the Schlenk flask. The Schlenk flask was then purged with nitrogen gas and placed on ice. After purging, anhydrous ammonia was introduced to the flask at 5 mL/min and the contents stirred at 200 rpm. The colorless solution gradually turned into a white gel-like slurry. After 5 hours, the ammonia flow was stopped, and the flask was purged with nitrogen for 30 minutes. Under nitrogen flow the rubber septum and tubes were replaced with the Schlenk stopper, and the flask was returned to a glovebox. The gel-like crude silicon diimide was filtered on a medium frit resulting in a white powder. The powder was transferred to a 250 mL round bottom flask fitted with a vacuum adapter and dried at 50° C. for 4 hours. The dried powder was then placed into a quartz boat which was then inserted into a horizontal quartz tube, which was fitted with ultra-torr fittings. The tube was sealed with three-way valves and placed on a horizontal tube furnace. The ends of the tube were connected to an inlet gas line and exhaust lines. The tube was purged for 5 minutes with nitrogen gas. After purging, anhydrous ammonia gas was introduced to the tube at 30 mL/min and the nitrogen gas flow was stopped. Under ammonia gas flow the tube was heated to 1000° C. (+5° C./min) for 2 hours and then cooled to room temperature. During the heating process ammonium chloride byproduct was sublimed and deposited at the exhaust side of the quartz tube. After cooling to room temperature (“RT”), the ammonia gas flow was stopped and the tube was purged with nitrogen gas for 1 hour. After purging the exhaust side, the three-way valve was shut, and a vacuum was pulled on the tube. Once the pressure reached <40 mtorr the tube was heated to 200° C. (+5° C./min) for 12 hours and then cooled back to RT. The tube was then sealed under vacuum (<20 mtorr) and transferred to a glovebox (nitrogen atmosphere). The final Si₃N₄ product was stored in a glovebox. Typical yield from 4 mL SiCl₄ is approximately 600 mg Si₃N₄.

Preparation of Silica. High purity silica gel (Sigma-Aldrich; Davisil Grade 646; 35-60 mesh; 150 Å; 300 m2/g) was treated at 200° C. under vacuum for 12 hours.

Grafting ZrBn₄ onto Silicon Nitride. Silicon nitride (600 mg) and toluene (30 mL) were added to a 250 mL round bottom flask and allowed to soak for 30 minutes on a shaker at 170 rpm. A solution of ZrBn₄ (340 mg, 0.75 mmol) and toluene was added dropwise to the silicon nitride. The contents were shaken at 170 rpm for 5 hours. The white silicon nitride became orange in color following the addition of ZrBn₄. The solution was then filtered on a fine frit, isolating an orange-colored powder, which was then soaked and rinsed with toluene and then pentane three times each. After filtering off the final pentane rinse, the orange powder was dried at RT under vacuum for 6 hours. The resultant dried orange product Zr/Si₃N₄ was transferred to a scintillation vial and weighed (Yield: 712 mg Zr/Si₃N₄).

Grafting ZrBn₄ onto Silica. Silica (500 mg), toluene (2.5 mL), and a stir bar were added to a 20 mL scintillation vial. ZrBn₄ (113.5 mg, 0.25 mmol), toluene (2.5 mL), and stir bar were added to a separate 20 mL scintillation vial. The ZrBn₄ solution was added dropwise to the stirring slurry of silica. The resultant mixture was stirred for 2.5 hours. The solution was then filtered on a fine frit, isolating an orange-colored powder, which was then soaked and rinsed with toluene and then pentane three times each. After filtering off the final pentane rinse, the orange powder was transferred to a new clean 20 mL scintillation vial and dried under vacuum for 6 hours. The resultant light orange colored Zr/SiO₂ powder was weighed yielding 515 mg.

### Computational Data.

Computational Methodology. Silicon nitride has two stable crystal phases, α-Si₃N₄ with trigonal system and β-Si₃N₄ with hexagonal system, and forms β-Si₃N₄ at high temperatures from the transition of α-Si₃N₄. The bulk structure of R—Si₃N₄ was chosen as a cluster framework to represent amorphous silicon nitride. The R—Si₃N₄ unit cell, including 14 atoms, was optimized by density functional theory (“DFT”) methods using the plane wave-based Vienna ab initio Simulation Package (“VASP”). The projector augmented wavefunctions (“PAW”) were employed to solve the Kohn-Sham equations with 550 eV cutoff energy and 6×6×6 k-point mesh with the Monkhorst-Pack scheme. The Perdew, Burke, and Ernzerhof (“PBE”) functional based on the generalized gradient approximation (“GGA”) was used to describe electron-exchange correlation energy. The optimized lattice parameters are a=b=7.661 Å and c=2.925 Å for the bulk P—Si₃N₄, which has the experimental lattice parameters as a=b=7.608 Å and c=2.911 Å. For the mechanistic study of the C—H activation in PDH, the Si₃N₄ and SiO₂ clusters were modeled to compare the catalytic performances. The Si₃N₄ cluster model consisting of 28 Si and 43 N atoms was obtained by fragmenting from the optimized bulk structure. The silica cluster used a silsequioxane cage with 11 Si and 19 O atoms to describe the amorphous silica surface. All cluster models were optimized with Gaussian16 by B3LYP density functional with CEP-31G basis set, and half of the Si₃N₄ and SiO₂ clusters were constrained during the optimization. The Gibbs free energy was computed by single-point energy calculations with def2-TZVP basis set incorporating thermal corrections at 450° C. through B3LYP/CEP-31G frequency calculation. The optimized geometries, obtained at the B3LYP/CEP-31G level of theory, were used for these calculations.

### Definitions

No claim element herein is to be construed under the provisions of 35 U.S.C. § 112(f), unless the element is expressly recited using the phrase “means for.”

As utilized herein, the terms “approximately,” “about,” “substantially,” and similar terms are intended to have a broad meaning in harmony with the common and accepted usage by those of ordinary skill in the art to which the subject matter of this disclosure pertains. It should be understood by those of skill in the art who review this disclosure that these terms are intended to allow a description of certain features described and claimed without restricting the scope of these features to the precise numerical ranges provided. Accordingly, these terms should be interpreted as indicating that insubstantial or inconsequential modifications or alterations of the subject matter described and claimed are considered to be within the scope of the disclosure as recited in the appended claims.

It should be noted that the term “exemplary” and variations thereof, as used herein to describe various embodiments, are intended to indicate that such embodiments are possible examples, representations, or illustrations of possible embodiments (and such terms are not intended to connote that such embodiments are necessarily extraordinary or superlative examples).

The term “coupled” and variations thereof, as used herein, means the joining of two members directly or indirectly to one another. Such joining may be stationary (e.g., permanent or fixed) or moveable (e.g., removable or releasable). Such joining may be achieved with the two members coupled directly to each other, with the two members coupled to each other using a separate intervening member and any additional intermediate members coupled with one another, or with the two members coupled to each other using an intervening member that is integrally formed as a single unitary body with one of the two members. If “coupled” or variations thereof are modified by an additional term (e.g., directly coupled), the generic definition of “coupled” provided above is modified by the plain language meaning of the additional term (e.g., “directly coupled” means the joining of two members without any separate intervening member), resulting in a narrower definition than the generic definition of “coupled” provided above. Such coupling may be mechanical, electrical, or fluidic. For example, circuit A communicably “coupled” to circuit B may signify that the circuit A communicates directly with circuit B (i.e., no intermediary) or communicates indirectly with circuit B (e.g., through one or more intermediaries).

As used herein, the singular forms “a,” “an,” and “the” include plural referents unless the context clearly dictates otherwise. Thus, for example, the term “a member” is intended to mean a single member or a combination of members, “a material” is intended to mean one or more materials, or a combination thereof.

As used herein, the terms “about” and “approximately” generally mean plus or minus 10% of the stated value. For example, about 0.5 would include 0.45 and 0.55, about 10 would include 9 to 11, about 1000 would include 900 to 1100.

The term “or,” as used herein, is used in its inclusive sense (and not in its exclusive sense) so that when used to connect a list of elements, the term “or” means one, some, or all of the elements in the list. Conjunctive language such as the phrase “at least one of X, Y, and Z,” unless specifically stated otherwise, is understood to convey that an element may be either X, Y, Z; X and Y; X and Z; Y and Z; or X, Y, and Z (i.e., any combination of X, Y, and Z). Thus, such conjunctive language is not generally intended to imply that certain embodiments require at least one of X, at least one of Y, and at least one of Z to each be present, unless otherwise indicated.

References herein to the positions of elements (e.g., “top,” “bottom,” “above,” “below”) are merely used to describe the orientation of various elements in the figures. It should be noted that the orientation of various elements may differ according to other exemplary embodiments, and that such variations are intended to be encompassed by the present disclosure.

It should be noted that the term “exemplary” as used herein to describe various embodiments is intended to indicate that such embodiments are possible examples, representations, and/or illustrations of possible embodiments (and such term is not intended to connote that such embodiments are necessarily extraordinary or superlative examples).

The terms “coupled,” “connected,” and the like as used herein mean the joining of two members directly or indirectly to one another. Such joining may be stationary (e.g., permanent) or moveable (e.g., removable or releasable). Such joining may be achieved with the two members or the two members and any additional intermediate members being integrally formed as a single unitary body with one another or with the two members or the two members and any additional intermediate members being attached to one another.

It is important to note that the construction and arrangement of the various exemplary embodiments are illustrative only. Although only a few embodiments have been described in detail in this disclosure, those skilled in the art who review this disclosure will readily appreciate that many modifications are possible (e.g., variations in sizes, dimensions, structures, shapes and proportions of the various elements, values of parameters, mounting arrangements, use of materials, colors, orientations, etc.) without materially departing from the novel teachings and advantages of the subject matter described herein. Other substitutions, modifications, changes and omissions may also be made in the design, operating conditions and arrangement of the various exemplary embodiments without departing from the scope of the present invention.

While this specification contains many specific implementation details, these should not be construed as limitations on the scope of any inventions or of what may be claimed, but rather as descriptions of features specific to particular implementations of particular inventions. Certain features described in this specification in the context of separate implementations can also be implemented in combination in a single implementation. Conversely, various features described in the context of a single implementation can also be implemented in multiple implementations separately or in any suitable subcombination. Moreover, although features may be described above as acting in certain combinations and even initially claimed as such, one or more features from a claimed combination can in some cases be excised from the combination, and the claimed combination may be directed to a subcombination or variation of a subcombination.

Although the figures and description may illustrate a specific order of method steps, the order of such steps may differ from what is depicted and described, unless specified differently above. Also, two or more steps may be performed concurrently or with partial concurrence, unless specified differently above.

It is important to note that any element disclosed in one embodiment may be incorporated or utilized with any other embodiment disclosed herein. Although only one example of an element from one embodiment that can be incorporated or utilized in another embodiment has been described above, it should be appreciated that other elements of the various embodiments may be incorporated or utilized with any of the other embodiments disclosed herein.

What is claimed is:

1. A catalyst composition comprising:
a support material comprising Si(_{3-(x/4})) (NH)ₓ N(₄₋ₓ), where X is 0-4 or SiₐOₓN_{y}; and
an active material comprising a metal-ligand complex wherein a metal is selected from the group consisting of Cr, Ga, V, Fe, Co, and Zr.

2. The catalyst composition of claim 1, wherein the support material comprises Si₃N₄.

3. The catalyst composition of claim 1, wherein the support material comprises Si(NH)₂.

4. The catalyst composition of claim 1, wherein the active material comprises Zr.

5. The catalyst composition of claim 1, further comprising a promotor.

6. The catalyst composition of claim 1, wherein the active material comprises Fe.

7. A method of preparing a propane dehydrogenation catalyst comprising:
forming a Si₃N₄ catalytic support; and
grafting a metal-ligand complex onto the catalytic support.

8. The method of claim 7, where the grafting is by a method selected from the group consisting of impregnation, incipient wetness impregnation, strong electrostatic adsorption, atomic layer deposition, and chemical vapor deposition.

9. The method of claim 7, wherein the metal ligand complex comprises a metal selected from the group consisting of Cr, Ga, V, Fe, Co, and Zr.

10. The method of claim 7, wherein the metal ligand complex comprises a ligand selected from the group consistent of alkyl groups, aryl, metal amides, metal alkoxide, and metal hydrides.

11. The method of claim 7, wherein the Si₃N₄ catalytic support is formed from a silicon tetrachloride precursor.

12. The method of claim 7, wherein the active material comprises Zr.

13. A catalyst composition comprising:
a support material comprising Si₃N₄, and
an active material grafted to the support material, the active material comprising a metal-ligand complex wherein a metal is selected from the group consisting of Cr, V, Fe, and Zr;
wherein the active material comprises a catalytic site for heterolytic C—H bond cleavage across a metal oxide bond that includes the metal.

14. The catalyst composition of claim 13, wherein the active material comprises Zr.

15. The catalyst composition of claim 13, further comprising a promotor.

16. The catalyst composition of claim 13, wherein the active material comprises Fe.
